(19) United States
(12) Patent Application Publication
(10) Pub. No.: US 2012/0147069 A1
(43) Pub. Date: Jun. 14, 2012

(54) LIQUID CRYSTAL DISPLAY AND METHOD FOR DRIVING PANEL THEREOF

(75) Inventors: Ping-Lin Chen, Kaohsiung City (TW); Yi-Suei Liao, Kaohsiung City (TW)

(73) Assignee: AU OPTRONICS CORPORATION, Hsinchu (TW)

(21) Appl. No.: 13/026,310

(22) Filed: Feb. 14, 2011

(30) Foreign Application Priority Data
Dec. 8, 2010 (TW) 99142828

(51) Int. Cl. G09G 3/36; G09G 5/00; G09G 5/10

(52) U.S. Cl. 345/691; 345/204; 345/102

(57) ABSTRACT

A liquid crystal display and a method for driving a liquid crystal display panel thereof are provided. The method includes sequentially generating a plurality of first scan signals to first ends of a plurality of scan lines in the liquid crystal display panel; sequentially generating a plurality of second scan signals to second ends of the scan lines; and coordinating with the generation of each of the first scan signals or the generation of each of the second scan signals to correspondingly generate a plurality of data signals to a plurality of data lines in the liquid crystal display panel. The i^{th} scan line and the (i+N)^{th} scan line receive respectively the corresponding first scan signal and the corresponding second scan signal at the same time, where i is a positive integer and N is determined by a driving manner of the liquid crystal display panel.

### CROSS-REFERENCE TO RELATED APPLICATION

This application claims the priority benefit of Taiwan application serial no. 99142828, filed on Dec. 8, 2010. The entirety of the above-mentioned patent application is hereby incorporated by reference herein and made a part of this specification.

### BACKGROUND OF THE INVENTION

1. Field of the Invention

The present invention relates to a flat display technology, and more particularly, to a liquid crystal display and a method for driving a panel thereof.

2. Description of Related Art

Recently, with the vigorous development of semiconductor technology, portable electronic products and flat panel display (FPD) products also rise. Among many types of the FPDs, the liquid crystal display (LCD) immediately becomes the mainstream of various display products due to advantages such as low-voltage operation, radiation-free line scattering, a light weight, and a small volume.

Current driving method for the LCD panel mostly uses a single gate driver to sequentially generate a plurality of scan signals to scan lines in the LCD panel and thus performing the pixel-on operations. A source driver is used to coordinate with the generation of each scan signal to correspondingly generate a plurality of data signals to a plurality of data lines in the LCD panel and thus performing the pixel writing operations.

However, when the resolution of the LCD panel increases or a half source driving (HSD) or a tri-gate driving structure is used, the enabling period of each scan signal generated by the gate driver is reduced, which may be reduced to one second or one third of its original value. Accordingly, the time for pixel-writing is reduced which may lead to an insufficient pixel charging time. In order to overcome such problem, the size of the thin film transistor (TFT) of the pixel may be increased to enhance the driving capability. However, such method would sacrifice the pixel's aperture ratio (AR).

### SUMMARY OF THE INVENTION

Accordingly, the present invention is directed to a liquid crystal display (LCD) and a method for driving a liquid crystal display panel which can effectively solving the problem mentioned in the prior art.

The present invention provides a method for driving a liquid crystal display panel, and the method includes sequentially generating a plurality of first scan signals to first ends of a plurality of scan lines in the liquid crystal display panel; sequentially generating a plurality of second scan signals to second ends of the scan lines; and coordinating with the generation of each of the first scan signals or the generation of each of the second scan signals to correspondingly generate a plurality of data signals to a plurality of data lines in the liquid crystal display panel. The i^{th} scan line and the (i+N)^{th} scan line receive respectively the corresponding first scan signal and the corresponding second scan signal at the same time, where i is a positive integer and N is determined by a driving manner of the liquid crystal display panel.

The present invention also provides a liquid crystal display, and the liquid crystal display includes a liquid crystal display panel, a first gate driver, a second gate driver, and a source driver. The first gate driver is coupled to the liquid crystal display panel for sequentially generating a plurality of first scan signals to first ends of a plurality of scan lines in the liquid crystal display panel. The second gate driver is coupled to the liquid crystal display panel for sequentially generating a plurality of second scan signals to second ends of the scan lines. The source driver is coupled to the liquid crystal display panel for coordinating with the generation of each of the first scan signals or the generation of each of the second scan signals to correspondingly generate a plurality of data signals to a plurality of data lines in the liquid crystal display panel. The i^{th} scan line and the (i+N)^{th} scan line receive respectively the corresponding first scan signal and the corresponding second scan signal at the same time, where i is a positive integer and N is determined by a driving manner of the liquid crystal display panel.

In one embodiment of the present invention, an enabling period of each of the first scan signals is equal or unequal to an enabling period of each of the second scan signals.

In one embodiment of the present invention, two pixel rows in the liquid crystal display panel are simultaneously charged in response to the data signals, one of the two pixel rows is real-charged in response to the data signals while the other of the two pixel rows is pre-charged in response to the data signals.

In one embodiment of the present invention, the driving manner includes at least one of dot inversion, row inversion, column inversion and frame inversion.

From the above, in the present invention, (asynchronous) double-side driving of the scan lines in the LCD panel is used, such that real charging and pre-charging operations may be performed on two pixel rows in the LCD panel at the same time in response to the data signals generated by the source driver. As a result, the pixel's charging ratio can be significantly increased, thereby reducing the size of the TFT of the pixels so as to increase the pixel's aperture ratio.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a system block diagram of a liquid crystal display according to one embodiment of the present invention.

FIG. 2A to FIG. 2E illustrate driving schemes of the liquid crystal display panel according to embodiments of the present invention, respectively.

FIG. 3 illustrates a flow chart of a driving method of the LCD panel according to one embodiment of the present invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

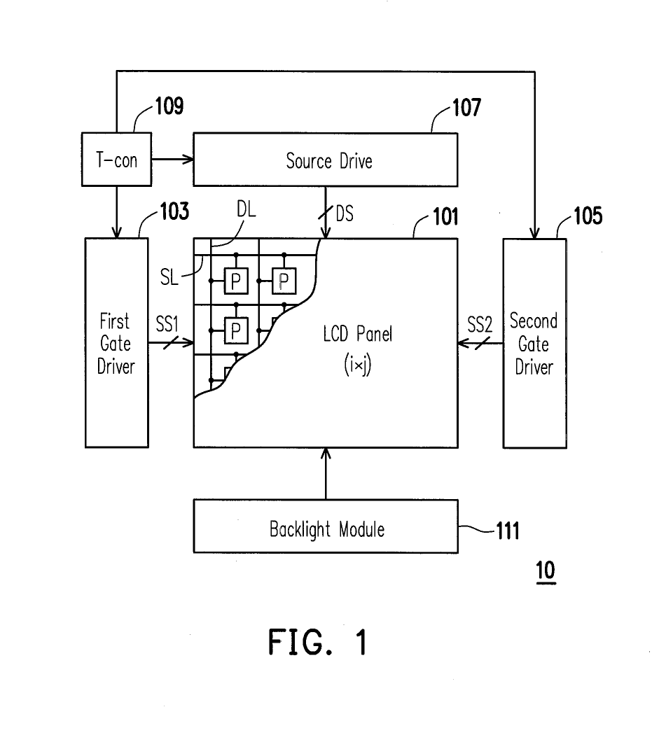

FIG. 1 illustrates a system block diagram of a liquid crystal display (LCD) 10 according to one embodiment of the present invention. Referring to FIG. 1, the LCD 10 includes an LCD panel 101, a first gate driver 103, a second gate driver 105, a source driver 107, a timing controller (T-con) 109, and a backlight module 111. The LCD panel 101 includes a plurality of scan lines SL, a plurality of data lines DL, and a plurality of pixels P arranged in array. Each pixel P is electrically connected with the corresponding one of the data lines DL and the corresponding one of the scan lines SL.

The first gate driver 103 is coupled to the LCD panel 101 for sequentially generating a plurality of first scan signals SS1 to first ends of the corresponding scan lines SL, so as to perform the pixel-on operations; similarly, the second gate driver 105 is coupled to the LCD panel 101 for sequentially generating a plurality of second scan signals SS2 to second ends of the corresponding scan lines SL, so as to perform the pixel-on operations.

It is noted that the first and second scan signals SS1 and SS2 generated respectively by the first and second gate drivers 103 and 105 do not drive one same scan line at the same time. That is, the first and second ends of one same scan line SL do not receive both the first and second scan signals SS1 and SS2 at the same time. In addition, in the present embodiment, the first and second gate drivers 103 and 105 may be disposed respectively on opposite sides of the LCD panel 101 (i.e. the gate drivers are directly formed on a glass substrate of the LCD panel 101 by using a gate on array (GOA) technique) or disposed respectively outside opposite sides of the LCD panel 101 (i.e. the gate drivers are formed on printed circuit boards outside the LCD panel 101), and an enabling period of each first scan signal SS1 may be equal or unequal to an enabling period of each second scan signal SS2.

The source driver 107 is coupled to the LCD panel 101 for coordinating with the generation of each first scan signal SS1 or the generation of each second scan signal SS2 to correspondingly generate a plurality of data signals DS to the corresponding data lines DL, so as to perform the pixel-writing operations. The T-con 109 is coupled to the first and second gate drivers 103 and 105 and the source driver 107 to control operations of the first and second gate drivers 103 and 105 and the source driver 107. The backlight module 111 is used to provide the (back) light source required by the LCD panel 101. As such, the LCD panel 101 displays images to users in response to the driving of the first and second gate drivers 103 and 105 and the source driver 107 and the (back) light source provided by the backlight module 111.

Herein, please review the contents of the prior art, that is, when the resolution of the LCD panel increases or a half source driving (HSD) or a tri-gate driving structure is used, the enabling period of each scan signal generated by the gate driver is reduced, which may be reduce to one second or one third of its original value. Accordingly, the time for pixel-writing is reduced which may result in an insufficient pixel charging time. In order to overcome such problem, the size of the thin film transistor (TFT) of the pixel may be increased to enhance the driving capability. However, such method would sacrifice the pixel's aperture ratio.

In view of the foregoing, in the present embodiment, (asynchronous) double-side driving of the scan lines SL in the LCD panel 101 is specially used, such that real charging and pre-charging operations may be performed on two pixel rows in the LCD panel 101 at the same time in response to the data signals DS generated by the source driver 107, thereby solving/improving the problem mentioned in the prior art.

More specifically, in the present embodiment, the i^{th} scan line SLᵢ and (i+N)^{th} scan line SL_{i+N} in the LCD panel 101 may respectively receive the first scan signal SS1 and second scan signal SS2 at the same time, where i is a positive integer, and N is determined by the driving manner of the LCD panel 101, i.e. at least one of dot inversion, row inversion, column inversion and frame inversion.

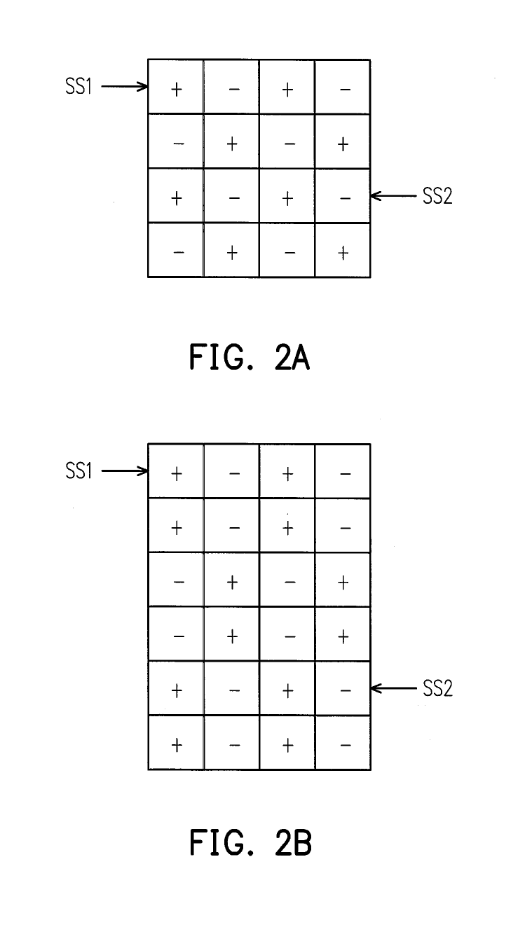

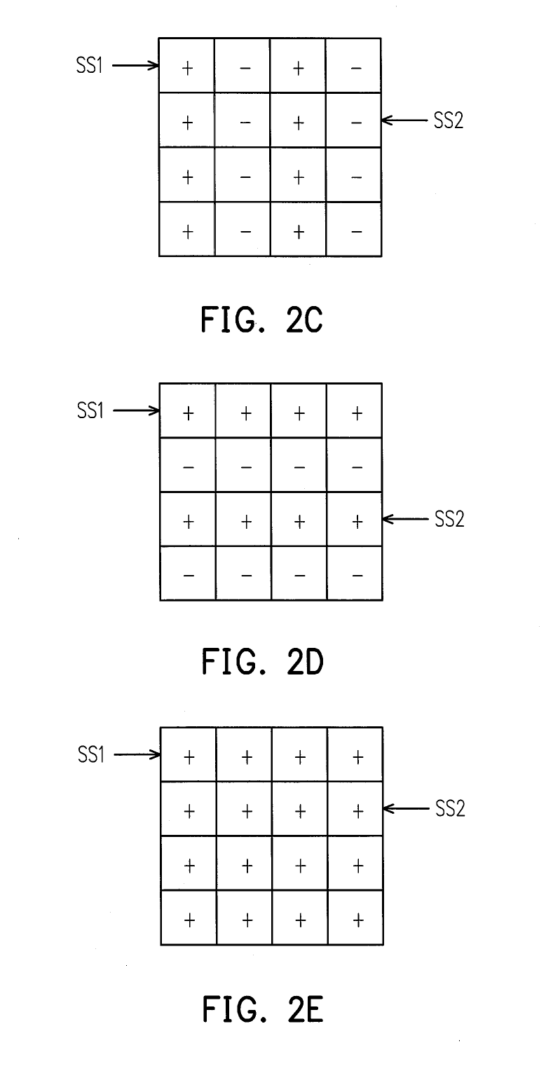

For example, as shown in FIG. 2A, assuming the LCD panel 101 has 4*4 pixels P and is driven in the manner of single-dot inversion, the T-con 109 may control the first gate driver 103 to generate a first scan signal SS1 to turn the first pixel row on and coordinately control the source driver 107 to, for example, generate four data signals DS respectively relating to positive (+), negative (−), positive (+), negative (−) to perform real charging on the first pixel row (i.e. correct voltage level). Meanwhile, the T-con 109 may control the second gate driver 105 to generate a second scan signal SS2 to turn the third pixel row on (i.e. the first and third pixel rows are simultaneously turned on), such that the same four data signals DS can be used to pre-charge the third pixel row (i.e. incorrect voltage level). It can thus be seen that the source driver 107 correspondingly generates the data signals DS in response to the generation of each first scan signal SS1 in the present embodiment, but may generate the data signals DS in response to the generation of each second scan signal SS2 in another embodiment of the present invention, depending upon actual requirements.

Next, when the first gate driver 103 generates a first scan signal SS1 to turn the third pixel row on, since the third pixel row have been pre-charged, another four data signals DS respectively relating to positive (+), negative (−), positive (+), negative (−), generated by the source driver 107 at this time are used to perform real charging on the third pixel row. Since the third pixel row have been pre-charged, the source driver 107 now needs only to charge the third pixel row from the pre-charged voltage level. Therefore, the charging ratio of the pixels P can be significantly increased, such that the size of the TFT of the pixels P can be reduced so as to increase the aperture ratio of the pixels P.

For another example, as shown in FIG. 2B, assuming the LCD panel 101 has 4*6 pixels P and is driven in the manner of two-dot inversion, the T-con 109 may control the first gate driver 103 to generate a first scan signal SS1 to turn the first pixel row on and coordinately control the source driver 107 to, for example, generate four data signals DS respectively relating to positive (+), negative (−), positive (+), negative (−) to perform real charging on the first pixel row. Meanwhile, the T-con 109 may control the second gate driver 105 to generate a second scan signal SS2 to turn the fifth pixel row on (i.e. the first and fifth pixel rows are simultaneously turned on), such that the same four data signals DS can be used to pre-charge the fifth pixel row.

Next, when the first gate driver 103 generates a first scan signal SS1 to turn the fifth pixel row on, since the fifth pixel row have been pre-charged, another four data signals DS respectively relating to positive (+), negative (−), positive (+), negative (−), generated by the source driver 107 at this time are used to perform real charging on the fifth pixel row. Since the fifth pixel row have been pre-charged, the source driver 107 now needs only to charge the fifth pixel row from the pre-charged voltage level. Therefore, the charging ratio of the pixels P can be significantly increased, such that the size of the TFT of the pixels P can be reduced so as to increase the aperture ratio of the pixels P.

For another example, as shown in FIG. 2C, assuming the LCD panel 101 has 4*4 pixels P and is driven in the manner of column inversion, the T-con 109 may control the first gate driver 103 to generate a first scan signal SS1 to turn the first pixel row on and coordinately control the source driver 107 to, for example, generate four data signals DS respectively relating to positive (+), negative (−), positive (+), negative (−) to perform real charging on the first pixel row. Meanwhile, the T-con 109 may control the second gate driver 105 to generate a second scan signal SS2 to turn the second pixel row on (i.e. the first and second pixel rows are simultaneously turned on), such that the same four data signals DS can be used to pre-charge the second pixel row.

Next, when the first gate driver 103 generates a first scan signal SS1 to turn the second pixel row on, since the second pixel row have been pre-charged, another four data signals DS respectively relating to positive (+), negative (−), positive (+), negative (−), generated by the source driver 107 at this time are used to perform real charging on the second pixel row. Since the second pixel row have been pre-charged, the source driver 107 now needs only to charge the second pixel row from the pre-charged voltage level. Therefore, the charging ratio of the pixels P can be significantly increased, such that the size of the TFT of the pixels P can be reduced so as to increase the aperture ratio of the pixels P.

For another example, as shown in FIG. 2D, assuming the LCD panel 101 has 4*4 pixels P and is driven in the manner of row inversion, the T-con 109 may control the first gate driver 103 to generate a first scan signal SS1 to turn the first pixel row on and coordinately control the source driver 107 to, for example, generate four data signals DS respectively relating to positive (+), positive (+), positive (+), positive (+) to perform real charging on the first pixel row. Meanwhile, the T-con 109 may control the second gate driver 105 to generate a second scan signal SS2 to turn the third pixel row on (i.e. the first and third pixel rows are simultaneously turned on), such that the same four data signals DS can be used to pre-charge the third pixel row.

Next, when the first gate driver 103 generates a first scan signal SS1 to turn the third pixel row on, since the third pixel row have been pre-charged, another four data signals DS respectively relating to positive (+), positive (+), positive (+), positive (+), generated by the source driver 107 at this time are used to perform real charging on the third pixel row. Since the third pixel row have been pre-charged, the source driver 107 now needs only to charge the third pixel row from the pre-charged voltage level. Therefore, the charging ratio of the pixels P can be significantly increased, such that the size of the TFT of the pixels P can be reduced so as to increase the aperture ratio of the pixels P.

For another example, as shown in FIG. 2E, assuming the LCD panel 101 has 4*4 pixels P and is driven in the manner of frame inversion, the T-con 109 may control the first gate driver 103 to generate a first scan signal SS1 to turn the first pixel row on and coordinately control the source driver 107 to, for example, generate four data signals DS respectively relating to positive (+), positive (+), positive (+), positive (+) to perform real charging on the first pixel row. Meanwhile, the T-con 109 may control the second gate driver 105 to generate a second scan signal SS2 to turn the second pixel row on (i.e. the first and second pixel rows are simultaneously turned on), such that the same four data signals DS can be used to pre-charge the second pixel row.

Next, when the first gate driver 103 generates a first scan signal SS1 to turn the second pixel row on, since the second pixel row have been pre-charged, another four data signals DS respectively relating to positive (+), positive (+), positive (+), positive (+), generated by the source driver 107 at this time are used to perform real charging on the second pixel row. Since the second pixel row have been pre-charged, the source driver 107 now needs only to charge the second pixel row from the pre-charged voltage level. Therefore, the charging ratio of the pixels P can be significantly increased, such that the size of the TFT of the pixels P can be reduced so as to increase the aperture ratio of the pixels P.

In view of the foregoing description, in the LCD panel 101, the two scan lines (SLᵢ, SL_{i+N}) capable of receiving a first scan signal SS1 and a second scan signal SS2, respectively, at the same time, are determined by the driving manner of the LCD panel 101. In addition, upon reading the teachings of the above description, people skilled in the art would appreciate that the first and second scan signals SS1 and SS2 generated respectively by the first and second gate drivers 103 and 105 could be used with an LCD panel 101 that is driven in a manner different from those described above without departing from the spirit of the present invention.

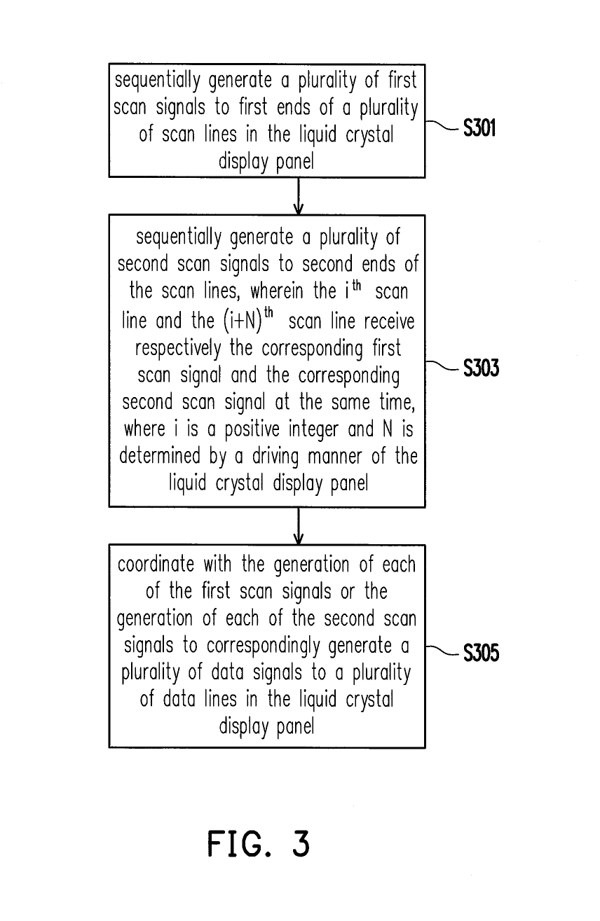

In addition, FIG. 3 illustrates a flow chart of a driving method of the LCD panel according to one embodiment of the present invention. Referring to FIG. 3, the driving method of the present embodiment includes sequentially generating a plurality of first scan signals SS1 to first ends of the scan lines SL (step S301); sequentially generating a plurality of second scan signals SS2 to second ends of the scan lines SL (step S303), wherein an enabling period of each first scan signal SS1 may be equal or unequal to an enabling period of each second scan signal SS2; and coordinating with the generation of each first scan signal SS1 or the generation of each second scan signal SS2 to correspondingly generate a plurality of data signals DS to a plurality of data lines DL in the LCD panel (step S305).

In the present embodiment, the i^{th} scan line and (i+N)^{th} scan line can receive respectively the corresponding first scan signal and the corresponding second scan signal at the same time, where i is a positive integer and N is determined by the driving manner of the LCD panel, i.e. at least one of dot inversion, row inversion, column inversion and frame inversion. Accordingly, two pixel rows in the LCD panel are simultaneously charged in response to the data signals generated by the source driver, one of the two pixel rows is real-charged (i.e. the liquid crystal molecule is rotated to a correct angle) in response to the data signals while the other of the two pixel rows is pre-charged (i.e. the liquid crystal molecule is rotated to an incorrect angle) in response to the data signals.

In summary, in the present embodiment, (asynchronous) double-side driving of the scan lines of the LCD panel is used, such that real charging and pre-charging operations may be performed on two pixel rows in the LCD panel at the same time in response to the data signals generated by the source driver. As a result, the pixel's charging ratio can be significantly increased, thereby reducing the size of the TFT of the pixels so as to increase the pixel's aperture ratio.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for driving a liquid crystal display panel, comprising:
sequentially generating a plurality of first scan signals to first ends of a plurality of scan lines in the liquid crystal display panel;
sequentially generating a plurality of second scan signals to second ends of the scan lines; and
coordinating with the generation of each of the first scan signals or the generation of each of the second scan signals to correspondingly generate a plurality of data signals to a plurality of data lines in the liquid crystal display panel,
wherein the i^{th} scan line and the (i+N)^{th} scan line receive respectively the corresponding first scan signal and the corresponding second scan signal at the same time, where i is a positive integer and N is determined by a driving manner of the liquid crystal display panel.

2. The method according to claim 1, wherein an enabling period of each of the first scan signals is equal or unequal to an enabling period of each of the second scan signals.

3. The method according to claim 1, wherein two pixel rows in the liquid crystal display panel are simultaneously charged in response to the data signals, one of the two pixel rows is real-charged in response to the data signals while the other of the two pixel rows is pre-charged in response to the data signals.

4. The method according to claim 1, wherein the driving manner comprises at least one of dot inversion, row inversion, column inversion and frame inversion.

5. A liquid crystal display, comprising:
a liquid crystal display panel;
a first gate driver coupled to the liquid crystal display panel for sequentially generating a plurality of first scan signals to first ends of a plurality of scan lines in the liquid crystal display panel;
a second gate driver coupled to the liquid crystal display panel for sequentially generating a plurality of second scan signals to second ends of the scan lines; and
a source driver coupled to the liquid crystal display panel for coordinating with the generation of each of the first scan signals or the generation of each of the second scan signals to correspondingly generate a plurality of data signals to a plurality of data lines in the liquid crystal display panel,
wherein the i^{th} scan line and the (i+N)^{th} scan line receive respectively the corresponding first scan signal and the corresponding second scan signal at the same time, where i is a positive integer and N is determined by a driving manner of the liquid crystal display panel.

6. The liquid crystal display according to claim 5, wherein an enabling period of each of the first scan signals is equal or unequal to an enabling period of each of the second scan signals.

7. The liquid crystal display according to claim 5, wherein the liquid crystal display panel further comprises a plurality of pixels arranged in array and each electrically connected the corresponding data line and the correspondingly scan line, two pixel rows in the liquid crystal display panel are simultaneously charged in response to the data signals, one of the two pixel rows is real-charged in response to the data signals while the other of the two pixel rows is pre-charged in response to the data signals.

8. The liquid crystal display according to claim 5, further comprising:
a timing controller coupled to the first gate drive, the second gate driver and the source driver for controlling operations of the first gate driver, the second gate driver and the source driver; and
a backlight module for providing a backlight source required by the liquid crystal display panel.

9. The liquid crystal display according to claim 5, wherein the first gate driver and the second gate driver are disposed respectively on opposite sides of the liquid crystal display panel or disposed respectively outside opposite sides of the liquid crystal display panel.

10. The liquid crystal display according to claim 5, wherein the driving manner comprises at least one of dot inversion, row inversion, column inversion and frame inversion.
